(19) United States
(12) Patent Application Publication
(10) Pub. No.: US 2023/0035937 A1
(43) Pub. Date: Feb. 2, 2023

(54) INFORMATION PROCESSING SYSTEM

(71) Applicant: AISIN CORPORATION, Kariya (JP)

(72) Inventors: Taichi NAKAMURA, Kariya-shi (JP); Ze WU, Kariya (JP)

(73) Assignee: AISIN CORPORATION, Kariya (JP)

(21) Appl. No.: 17/866,881

(22) Filed: Jul. 18, 2022

(30) Foreign Application Priority Data
Jul. 29, 2021 (JP) 2021-123999

(51) Int. Cl. G01C 21/34; G01C 21/36

(52) U.S. Cl. CPC G01C 21/3484; G01C 21/367

(57) ABSTRACT

Provided is a system including a position acquisition unit that acquires a designated position; and an output control unit that causes an output unit to output cluster information based on a result of clustering target objects to be clustered by using a feature amount corresponding to each of the target objects, in which the target objects are a plurality of objects about a plurality of facilities, the cluster information being information on clusters to which objects about associated facilities belong, in which the facilities are associated with the position.

### INCORPORATION BY REFERENCE

The disclosure of Japanese Patent Application No. 2021-123999 filed on Jul. 29, 2021 including the specification, drawings and abstract is incorporated herein by reference in its entirety.

### BACKGROUND OF THE INVENTION

The present disclosure relates to an information processing system.

### Description of the Related Art

There is a technique of presenting facilities such as restaurants and sightseeing spots to a user. Japanese Unexamined Patent Application Publication No. 2016-176699 (JP 2016-176699 A) discloses a technique of providing guidance on a route from a present location to a destination while presenting facilities such as restaurants and gas stations positioned along the route as classified based on the attribute of the facilities recorded in advance in facility data.

### SUMMARY OF THE DISCLOSURE

JP 2016-176699 A involves an issue that it is difficult for a user to intuitively determine what each facility is like when a plurality of facilities of the same kind is presented. The aspects of the present disclosure have been made in view of the above issue, and therefore has an object to present to a user what facilities are included among facilities associated with a designated position in such a manner that facilitates making a determination.

In order to achieve the above aspects, an information processing system includes: a position acquisition unit that acquires a designated position; and an output control unit that causes an output unit to output cluster information based on a result of clustering target objects to be clustered that are a plurality of objects about a plurality of facilities, by using a feature amount corresponding to each of the target objects belong, the cluster information being information on clusters to which objects about associated facilities that are associated with the position.

That is, with the information processing system, a plurality of objects about a plurality of facilities are clusters formed by clustering, and information on clusters that include objects about facilities associated with the designated position is output to the output unit and presented to a user. Therefore, the user can easily grasp what facilities are included in the facilities associated with the designated position by confirming the presented information on the clusters.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 illustrates an example of the configuration of a facility information presentation system;

FIG. 2 illustrates an example of the structure of a model;

FIG. 3 is a sequence diagram illustrating an example of a facility information presentation process;

FIG. 4 illustrates an example of display of a route that has been found;

FIG. 5 illustrates an example of display of cluster information; and

FIG. 6 illustrates an example of display of information on facilities.

### DETAILED DESCRIPTION OF THE EMBODIMENTS

Embodiments of the present disclosure will be described in the following order.

### (1) Configuration of Facility Information Presentation System

### (2) Facility Information Presentation Process

### (3) Other Embodiments:

### (1) Configuration of Facility Information Presentation System

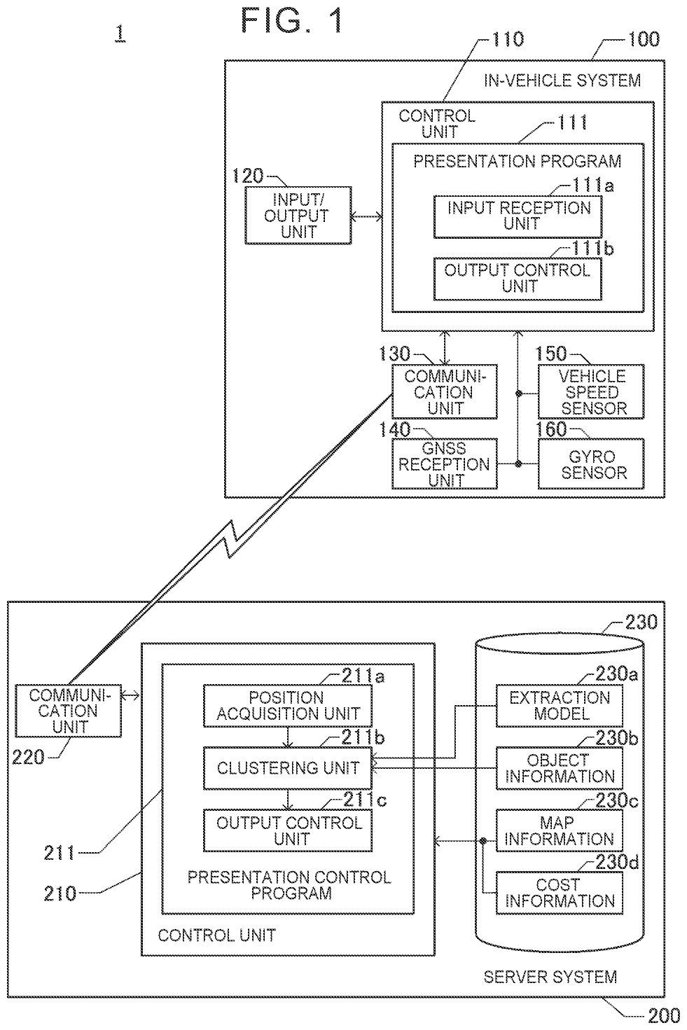

FIG. 1 illustrates an example of the configuration of a facility information presentation system 1 according to the present embodiment. The facility information presentation system 1 according to the present embodiment includes an in-vehicle system 100 and a server system 200. The in-vehicle system 100 is an information processing system provided in a vehicle of a user, and may be a car navigation system in the present embodiment. In the following, the vehicle provided with the in-vehicle system 100 will be referred to simply as a “vehicle”. The server system 200 is an information processing system that performs a route search etc. in accordance with a request from the in-vehicle system 100. In the present embodiment, the server system 200 clusters a plurality of objects about a plurality of facilities in accordance with a request from the in-vehicle system 100, and transmits information on requested clusters to the in-vehicle system 100. The term “facilities” refers to places that the user may have interest in and pay a visit to, and may be restaurants, sightseeing spots, retail stores, leisure facilities, etc., for example. In the present embodiment, the facilities are restaurants. The phrase “objects about facilities” refers to objects related to the facilities in any way, and may be images about the facilities (e.g. images of the appearance of the facilities, images of food and drink served at the facilities, etc.), the facilities themselves, texts about the facilities (e.g. reviews, introductions, etc.), etc., for example. In the present embodiment, the objects about facilities are images about the facilities. The in-vehicle system 100 presents the transmitted information on the clusters to the user.

The in-vehicle system 100 includes a control unit 110, an input/output unit 120, a communication unit 130, a global navigation satellite system (GNSS) reception unit 140, a vehicle speed sensor 150, and a gyro sensor 160. The control unit 110 includes a processor, a random access memory (RAM), and a read only memory (ROM), etc., and controls the in-vehicle system 100. The input/output unit 120 is used to receive an input of information from the user and present information to the user. The input/output unit 120 includes an input unit such as a touch screen, a hardware key, a hardware button, and a microphone that is used by the user to input information, and an output unit such as a display unit and a speaker that is used to present information to the user. The communication unit 130 includes a circuit that communicates with a different device such as the server system 200.

The GNSS reception unit 140 is a device that receives a signal from a global navigation satellite system, and receives radio waves from navigation satellites and outputs a signal that is used to derive the position of the vehicle. The control unit 110 acquires the signal to acquire the position of the vehicle. The vehicle speed sensor 150 outputs a signal corresponding to the rotational speed of wheels of the vehicle. The control unit 110 acquires a vehicle speed based on the signal. The gyro sensor 160 detects an angular acceleration for a turn of the vehicle within the horizontal plane, and outputs a signal corresponding to the orientation of the vehicle. The control unit 110 acquires the signal to acquire the travel direction of the vehicle. The vehicle speed sensor 150, the gyro sensor 160, etc. are used to specify a travel track of the vehicle. In the present embodiment, the control unit 110 acquires the present location of the vehicle by calculating the present location based on the departure position and the travel track of the vehicle and correcting the calculated present location of the vehicle based on the output signal from the GNSS reception unit 140.

The control unit 110 functions as an input reception unit 111a and an output control unit 111b by executing a presentation program 111 stored in a storage unit of the in-vehicle system 100. The input reception unit 111a has a function of receiving an input of information from the user via the input/output unit 120. The control unit 110 detects an operation of the input/output unit 120 by the user and receives an input of information corresponding to the detected operation through the function of the input reception unit 111a. In the present embodiment, the control unit 110 receives an input of the destination etc. of the user. The control unit 110 calculates the present location of the vehicle based on the departure position and the travel track of the vehicle and the output signal from the GNSS reception unit 140 through the function of the input reception unit 111a. The control unit 110 requests the server system 200 to search for a route from the departure location to the destination. When an input of the destination is received, the control unit 110 understands that the position of a route from the departure location to the destination, for which a search is to be made, has been designated by the user, and notifies the server system 200 that the position of a route from the departure location to the destination has been designated. In the following, the position designated by the user will be referred to as a “designated position”.

The output control unit 111b has a function of causing the input/output unit 120 to output information transmitted from the server system 200 (information such as a route, clusters formed by clustering predefined objects (e.g. images etc.) about facilities, and facilities). In the present embodiment, the control unit 110 causes the input/output unit 120 to output the information transmitted from the server system 200 by causing the input/output unit 120 to display such information through the function of the output control unit 111b.

The server system 200 includes a control unit 210, a communication unit 220, and a storage unit 230.

The control unit 210 includes a processor, a RAM, a ROM, etc., and controls the server system 200. The communication unit 220 includes a circuit that communicates with a different device such as the in-vehicle system 100. The storage unit 230 stores a presentation control program 211, an extraction model 230a, object information 230b, map information 230c, cost information 230d, etc. The extraction model 230a is a model that has been subjected to machine learning in advance to extract a feature amount from an input image. The term “model” refers to information (e.g. a formula etc.) that indicates the correspondence between input data and output data. It is only necessary that the extraction model 230a should be a model that has been subjected to machine learning so as to extract a feature amount from an image. The extraction model 230a can be configured as a model that includes a neural network (NN) such as a convolutional neural network (CNN) or a transformer. In the present embodiment, by way of example, the extraction model 230a is a model that includes a CNN.

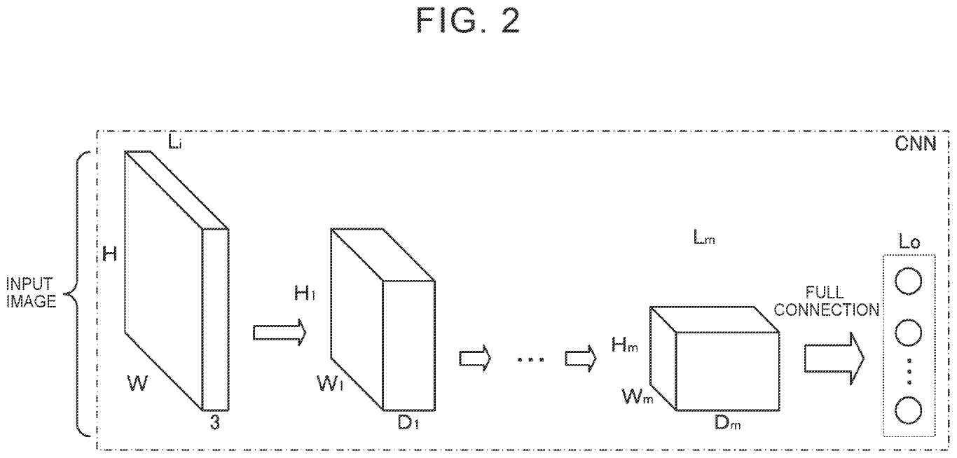

The extraction model 230a will be described. FIG. 2 illustrates an example of the configuration of the extraction model 230a. In FIG. 2, variations in the data format through the CNN are indicated by rectangular parallelepipeds. In the extraction model 230a, image data that indicate an input image are input to an input layer Lᵢ of the CNN, and output data are output to each node in an output layer Lₒ by way of one or more convolutional layers and one or more pooling layers. That is, a vector with a number of dimensions, the number corresponding to the number of nodes in the output layer Lₒ, is output from the extraction model 230a as the feature amount of the input image. The image data input to the CNN of the extraction model 230a has H pixels vertically and W pixels horizontally, and gradation values for three channels, namely red (R), green (G), and blue (B), are prescribed for each pixel. Thus, the image in the input layer Lᵢ is schematically indicated by a rectangular parallelepiped with a height of H, a width of W, and a depth of 3 in FIG. 2.

In the example illustrated in FIG. 2, the image input to the input layer Lᵢ is converted into a feature map with a height of H₁, a width of W₁, and a channel of D₁ through convolution operation performed using a predefined number of filters of a predefined size, operation performed using an activation function, and operation in the pooling layers. In FIG. 2, after that, the image is finally converted into a feature map with a height of Hₘ, a width of Wₘ, and a channel of Dₘ in a layer Lₘ, which is the final one of the convolutional layers, after passing by way of a plurality of layers. After a feature map with a height of Hₘ, a width Wₘ, and a channel of Dₘ is obtained through the CNN, the value of each node in the output layer Lₒ is obtained through full connection. In the present embodiment, the number of nodes in the output layer Lₒ is 512. Therefore, a vector with 512 dimensions is extracted from an image as the feature amount of the image by the extraction model 230a. In a different example, however, the number of nodes in the output layer Lₒ of the extraction model 230a may be set to a value that is different from 512.

The extraction model 230a has been subjected to machine learning in advance using teacher data in which images about the facilities (e.g. images of food and drink served at the facilities, images of the appearance of the facilities, etc.) and the kind (label) of food and drink served at the facilities are correlated with each other. More particularly, the extraction model 230a has been subjected to machine learning so as to render feature amounts output from images corresponding to the same label in the teacher data close to each other in the feature amount space and render feature amounts output from images corresponding to different labels in the teacher data away from each other in the feature amount space. However, the extraction model 230a may be a model that has been subjected to machine learning by a different learning method. For example, the extraction model 230a may be subjected to machine learning using images with no labels. For example, images generated by applying a random image conversion (e.g. extracting a part of the images, changing pixel values in the images, etc.) to prepared images with no labels are determined as converted images. Then, the extraction model 230a may be subjected to machine learning so as to render feature amounts output from converted images generated from the same image close to each other in the feature amount space and render feature amounts output from converted images generated from different images away from each other in the feature amount space. In a different example, the extraction model 230a may be a different model. For example, the extraction model 230a may be a model that discriminates the class of input images and that includes layers from an input layer to a predefined intermediate model extracted from a model that has been subjected to machine learning performed using teacher data in which images and labels are correlated with each other. Alternatively, the extraction model 230a may be a model that includes layers from an input layer to a layer from which a feature amount is output extracted from an autoencoder model that has been subjected to unsupervised learning and that extracts feature amounts from an image and reproduces the image from the extracted feature amounts.

The object information 230b is information on a plurality of images that is a plurality of predefined objects about a plurality of predefined facilities. Each of the images indicated by the object information 230b is an image about one of the plurality of predefined facilities. The object information 230b may include information on a plurality of images about the same facility. For example, the object information 230b may include, as images about the same restaurant, information on an image of pasta and an image of a hamburg steak served at the restaurant.

In the present embodiment, the object information 230b is information for each image on the correspondence among information on the image itself, position information (e.g. latitude, longitude, etc.) on the facility corresponding to the image, attribute information (e.g. facility name, genre of food and drink, etc.) on the facility corresponding to the image, and predefined feature amounts. The predefined feature amounts are feature amounts extracted in advance from the corresponding image by the control unit 210 using the extraction model 230a.

The map information 230c includes node data, shape interpolation point data, link data, data that indicate the position etc. of roads and facilities existing around the roads, etc. The data that indicate the position etc. of facilities include the attribute of the facilities. In the present embodiment, further, the link data include the length and the vehicle speed limit of road sections indicated by the link data. The cost information 230d indicates a passage cost for each road section indicated by the map information 230c. A passage cost to be applied when selecting a route is correlated with link data that indicate a road section. In the present embodiment, the passage cost is defined such that road sections with higher passage costs are less likely to be selected in a route.

The control unit 210 functions as a position acquisition unit 211a, a clustering unit 211b, and an output control unit 211c by executing the presentation control program 211 stored in the storage unit 230. The position acquisition unit 211a has a function of acquiring a designated position. The control unit 210 acquires a designated position designated by the user based on information transmitted from the in-vehicle system 100 through the function of the position acquisition unit 211a.

The clustering unit 211b has a function of clustering a plurality of facilities using feature amounts corresponding to a plurality of objects about the plurality of facilities that are targets to be clustered (feature amounts extracted from an image correlated with the facility by the extraction model 230a). In the following, the plurality of objects about the plurality of facilities that are targets to be clustered will be referred to as “target objects”. In the present embodiment, the target objects are each an image about any of the plurality of facilities. The feature amounts corresponding to a certain image as a target object are feature amounts extracted from the image by the extraction model 230a. The control unit 210 acquires, through the function of the clustering unit 211b, feature amounts correlated with images about the plurality of facilities associated with the position acquired through the function of the position acquisition unit 211a from the object information 230b. Then, the control unit 210 clusters the plurality of images so as to classify images correlated with similar feature amounts (at a short distance in the feature amount space) into the same cluster. The phrase “facilities associated with a certain position” refers to facilities that have a predefined relationship with the position (e.g. facilities existing along a route indicated by the position, facilities at less than a threshold distance from the position, facilities to which it takes less than a predefined threshold period to move from the position, etc.). In the following, the facilities associated with the designated position will be referred to as “associated facilities”.

The output control unit 211c has a function of causing the output unit of the input/output unit 120 of the in-vehicle system 100 to output information on clusters to which images about associated facilities, which are associated with the position acquired through the function of the position acquisition unit 211a, belong based on the result of the clustering performed through the function of the clustering unit 211b. The information on clusters indicates features of the clusters, and includes images themselves that belong to the clusters and information on the attribute etc. of facilities corresponding to the images that belong to the clusters, for example. In the following, the information on clusters will be referred to as “cluster information”. The control unit 210 transmits the cluster information on clusters formed as a result of the clustering performed through the function of the clustering unit 211b to the in-vehicle system 100 through the function of the output control unit 211c, and instructs the in-vehicle system 100 to display the transmitted cluster information on the input/output unit 120.

### (2) Facility Information Presentation Process

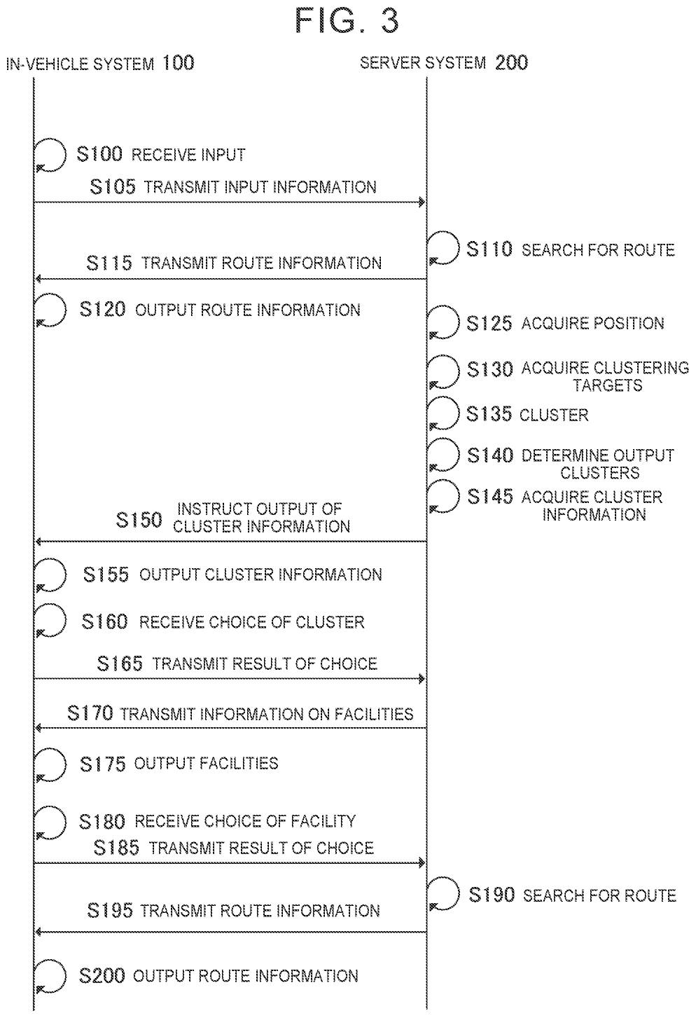

Processes performed by the facility information presentation system 1 according to the present embodiment will be described in detail with reference to the sequence diagram in FIG. 3. In the present embodiment, the facility information presentation system 1 starts the processes in FIG. 3 at the timing when the in-vehicle system 100 starts a route search application.

In step S100, the control unit 110 of the in-vehicle system 100 receives an input of a destination via the input/output unit 120 through the function of the input reception unit 111a. The control unit 110 also receives a condition (hereinafter referred to as a “facility condition”) for facilities to be presented via the input/output unit 120. The facility condition may be a condition that determines only facilities that have a predefined attribute value for a predefined attribute as targets to be presented (e.g. a condition that determines only facilities whose attribute value for the attribute “genre of food and drink” is “Italian” as targets to be presented) etc., for example. In the present embodiment, the facility condition determines only facilities that have a predefined attribute as targets to be presented. Then, the control unit 110 proceeds to the process in step S105.

In step S105, the control unit 110 obtains the present location of the vehicle based on the departure position and the travel track of the vehicle and the output signal from the GNSS reception unit 140 and determines the obtained present location as the departure location through the function of the input reception unit 111a. Then, the control unit 110 transmits the departure location, the destination received in S100, and the facility condition to the server system 200, and requests information on a route from the departure location to the destination and information on facilities on the route from the departure location to the destination. The control unit 210 also notifies the server system 200 that the position of the route from the departure location to the destination is determined as a designated position.

In step S110, the control unit 210 of the server system 200 searches for a route with the lowest cost from the departure location of the vehicle transmitted in step S105 to the destination by a predefined method such as a Dijkstra's algorithm based on the map information 230c and the cost information 230d through the function of the position acquisition unit 211a. However, the control unit 210 may search for a route using a cost for each road section that is different from the cost information 230d. Then, the control unit 210 proceeds to the process in step S115.

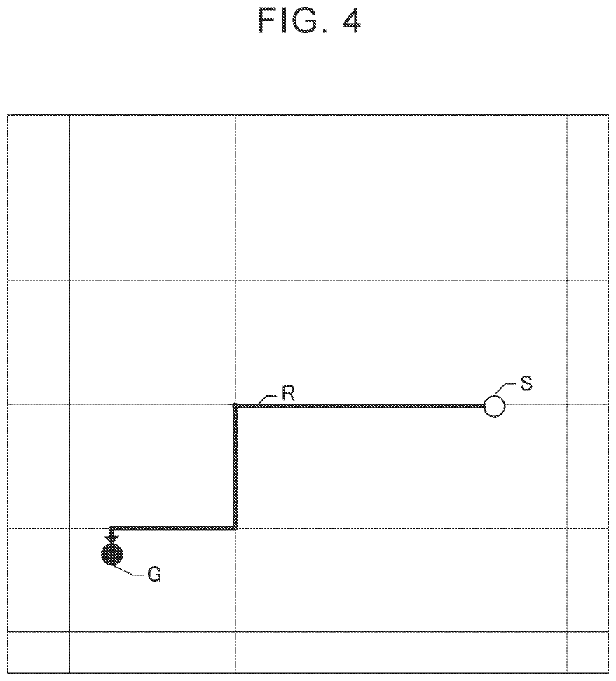

In step S115, the control unit 210 transmits the route found in step S110 to the in-vehicle system 100. Then, the control unit 210 proceeds to the process in step S125. When the route transmitted in step S115 is received, the control unit 110 of the in-vehicle system 100 causes the input/output unit 120 to display a map through the function of the output control unit 111b in step S120. Then, the control unit 210 displays the received route as superimposed on the displayed map. FIG. 4 illustrates an example of the route displayed on the input/output unit 120. The symbol “S” in FIG. 4 indicates the departure location. The symbol “G” indicates the destination. The symbol “R” indicates the route from the departure location to the destination.

In step S125, the control unit 210 of the server system 200 acquires the position of the route found in step S110 as the designated position through the function of the position acquisition unit 211a. Then, the control unit 210 proceeds to the process in step S130.

In step S130, the control unit 210 acquires information on images about associated facilities associated with the designated position from the object information 230b through the function of the clustering unit 211b. In the present embodiment, the control unit 210 acquires, as information on images about facilities associated with the designated position, information on images corresponding to facilities positioned along the route indicated by the designated position, among information on the plurality of images stored in the object information 230b. Then, the control unit 210 acquires, as information on the target objects, information on images corresponding to facilities, the attribute information on which matches the facility condition transmitted from the in-vehicle system 100, among information on the acquired images. Then, the control unit 210 proceeds to the process in step S135.

In step S135, the control unit 210 acquires, from the object information 230b, feature amounts correlated with the target objects, that is, feature amounts extracted from the corresponding images using the extraction model 230a, through the function of the clustering unit 211b. Then, the control unit 210 clusters the target objects using the acquired feature amounts. In the present embodiment, the control unit 210 clusters the target objects so as to form a predefined number of clusters using a k-means algorithm. In the present embodiment, the number of clusters is determined in advance. However, the control unit 210 may determine the value of the number of clusters. For example, the control unit 210 may determine the number of clusters based on the total number of the target objects, the total number of facilities corresponding to the target objects, etc. For example, the control unit 210 may determine a value obtained by dividing the total number of the target objects by a predefined numerical value (e.g. 10 etc.) as the number of clusters. The control unit 210 may determine a value obtained by dividing the total number of facilities corresponding to the target objects by a predefined numerical value as the number of clusters. Alternatively, the control unit 210 may receive designation of the number of clusters. When the target objects are clustered, the control unit 210 proceeds to the process in step S140.

In step S140, the control unit 210 determines clusters for which cluster information is to be output from the clusters formed as a result of the clustering performed in step S135 through the function of the output control unit 211c. In the present embodiment, the control unit 210 determines, as clusters for which cluster information is to be output, a predefined number of clusters determined sequentially in the descending order of the number of images included therein, among the obtained clusters. In the following, the clusters determined in step S140 will be referred to as “output clusters”. When clusters for which cluster information is to be output are determined, the control unit 210 proceeds to the process in step S145. In the present embodiment, a plurality of images about a plurality of associated facilities associated with the designated position is determined as clustering targets in step S130. Therefore, the output clusters determined in step S140 are clusters that include images about associated facilities associated with the designated position.

In step S145, the control unit 210 acquires, as cluster information on the output clusters, images themselves that represent the clusters through the function of the output control unit 211c. In the present embodiment, the control unit 210 acquires cluster information as follows. The control unit 210 extracts, for each of the output clusters, a predefined number of images as images that represent the cluster from the images included in the cluster. More specifically, the control unit 210 extracts, as images that represent the cluster, a predefined number of images, the feature amounts corresponding to which are the closest to the center of gravity of the cluster, among the images included in the cluster. In a different example, however, the control unit 210 may extract images that represent the cluster from the images included in the cluster by a different method. For example, the control unit 210 may arrange the images included in the cluster in the order of closeness of the corresponding feature amount to the center of gravity of the cluster and select representative images using a predefined number of quantiles. The control unit 210 may extract a predefined number of images at random from the images included in the cluster as images that represent the cluster. Then, the control unit 210 determines the images acquired for and representing each of the output clusters as cluster information. When cluster information is acquired for each of the output clusters, the control unit 210 proceeds to the process in step S150.

In step S150, the control unit 210 transmits the cluster information on each of the output clusters acquired in step S145 to the in-vehicle system 100 through the function of the output control unit 211c, and instructs the in-vehicle system 100 to output the transmitted cluster information to the input/output unit 120. In the present embodiment, the control unit 210 instructs the in-vehicle system 100 to display the cluster information for each cluster on the input/output unit 120 so as to be selectable.

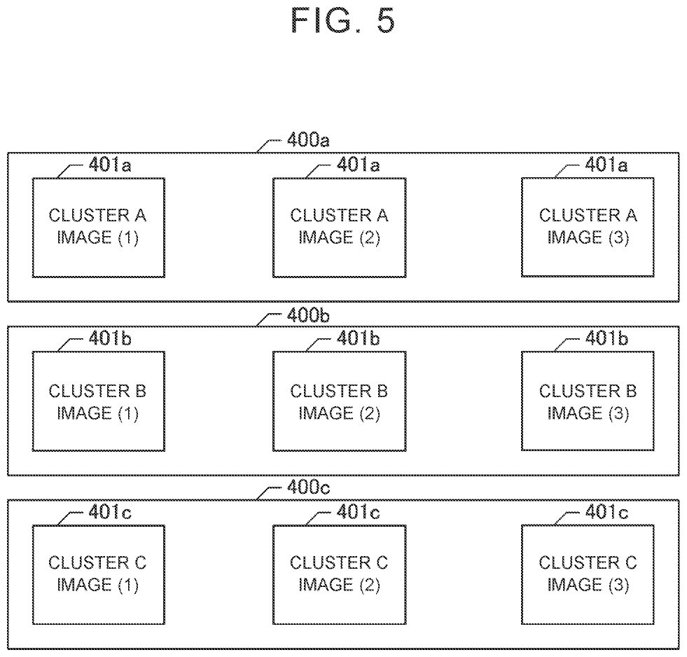

When the cluster information transmitted in step S150 is received, the control unit 110 of the in-vehicle system 100 causes the input/output unit 120 to display the cluster information through the function of the output control unit 111b in step S155. In the present embodiment, the cluster information to be output includes images for each cluster that represent the cluster. FIG. 5 illustrates an example of display of the cluster information. In the example of display of the cluster information in FIG. 5, there are three output clusters, and the cluster information includes three images that represent the cluster. The control unit 110 displays display fields 400 (400a to 400c in the example in FIG. 5) for the corresponding cluster information for each cluster included in the output clusters as arranged vertically so as to be selectable. Consequently, the user can easily confirm the cluster information for each cluster and select desired cluster information. Then, the control unit 110 displays three images 401 (401a to 401c in the example in FIG. 5) included in the corresponding cluster in each of the display fields 400 (400a to 400c) being displayed, as arranged horizontally. However, the control unit 210 may display the display fields 400 and the images 401 in a different display mode. For example, the display fields 400 may be arranged horizontally, and the images 401 may be arranged vertically in each of the display fields 400. The user can confirm images about associated facilities associated with the designated position (route from the departure location to the destination) by confirming the cluster information displayed on the input/output unit 120. Consequently, the user can easily grasp what facilities are included in the associated facilities. When the cluster information is displayed, the control unit 110 proceeds to the process in step S160.

In step S160, the control unit 110 receives a choice of one of the display fields 400 displayed for each cluster included in the output clusters based on an operation by the user on the input/output unit 120 through the function of the input reception unit 111a. Then, the control unit 110 proceeds to the process in step S165. In step S165, the control unit 110 transmits information that indicates the cluster corresponding to the display field 400, a choice of which has been received in step S160, to the server system 200 through the function of the input reception unit 111a.

When the information transmitted in step S165 is received, the control unit 210 of the server system 200 acquires information on facilities corresponding to images included in the cluster indicated by the received information from the object information 230b through the function of the output control unit 211c in step S170. In the present embodiment, the control unit 210 acquires images included in the cluster and information such as the positions of facilities corresponding to the images and the names of the facilities from the object information 230b. Then, the control unit 210 transmits the acquired information to the in-vehicle system 100.

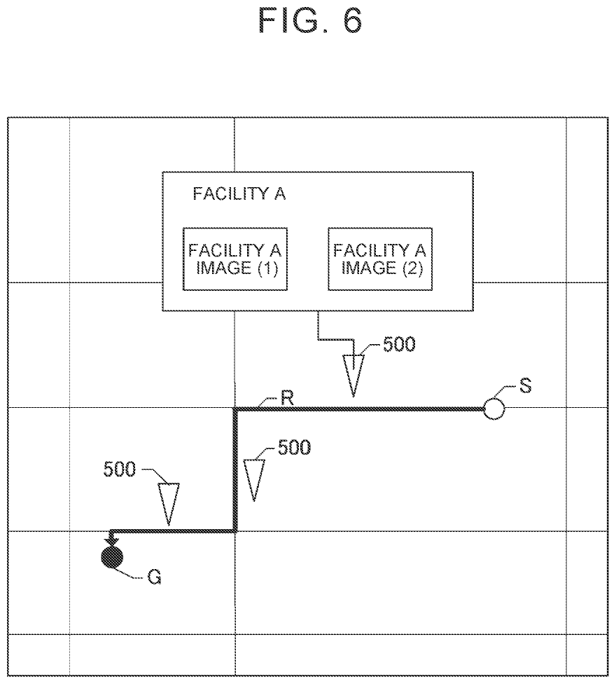

When the information transmitted in step S170 is received, the control unit 110 of the in-vehicle system 100 acquires the positions of the facilities from the received information through the function of the output control unit 111b in step S175. Then, the control unit 110 displays marks 500 corresponding to the facilities at the positions of the facilities on the map displayed in step S120 as illustrated in FIG. 6. The user can grasp what positions the facilities are located at by confirming the marks 500 in combination with the map. The marks 500 are an example of information that indicates the positions of the facilities. When a predefined operation (e.g. superposition of a cursor etc.) on a mark 500 is received, the control unit 110 causes the input/output unit 120 to display predefined information on facilities corresponding to the mark 500, an operation on which has been received (e.g. images about the facilities, attribute information on the facilities, etc.). In the example in FIG. 6, information on a facility A to be displayed in the case where a predefined operation is performed on a mark 500 corresponding to the facility A is indicated. In the example in FIG. 6, images about the facility A are displayed. The user can grasp the details of the facility by confirming the displayed information on the facility. When the marks 500 are displayed, the control unit 110 proceeds to the process in step S180.

In step S180, the control unit 110 receives a choice of one of the marks 500 based on an operation by the user on the input/output unit 120 through the function of the input reception unit 111a. Then, the control unit 110 proceeds to the process in step S185. In step S185, the control unit 110 transmits the information that indicates a facility corresponding to the mark 500 selected in step S180 to the server system 200 through the function of the input reception unit 111a, and requests the server system 200 to search for a route from the departure location to the destination by way of the facility.

In step S190, the control unit 210 of the server system 200 searches for a route from the departure location to the destination by way of the facility indicated by the information transmitted in step S185 by a predefined method such as a Dijkstra's algorithm based on the map information 230c and the cost information 230d through the function of the position acquisition unit 211a. Then, the control unit 210 proceeds to the process in step S195.

In step S195, the control unit 210 transmits the route found in step S190 to the in-vehicle system 100.

When the route transmitted in step S195 is received, the control unit 110 of the in-vehicle system 100 causes the input/output unit 120 to display a map through the function of the output control unit 111b in step S200. Then, the control unit 210 displays the received route as superimposed on the displayed map.

With the configuration according to the present embodiment, as described above, the facility information presentation system 1 presents, to the user, information on clusters formed by clustering a plurality of images about a plurality of associated facilities associated with the designated position and including the images about the associated facilities. The user can easily grasp what facilities are included in the facilities associated with the designated position by confirming the presented information on the clusters. In this manner, the facility information presentation system 1 can present what facilities are included in the associated facilities associated with the designated position to the user in such a manner that facilitates making a determination. In the present embodiment, the objects to be clustered are images about a plurality of associated facilities associated with the designated position. Therefore, it is possible to improve the possibility that clusters that indicate the characteristics of the designated position can be obtained as a result of clustering. For example, in the case where the facilities are restaurants, there is a possibility that clusters of images about facilities that provide local cuisine associated with the designated position are formed by determining objects about a plurality of associated facilities associated with the designated position as targets to be clustered. Consequently, the facility information presentation system 1 can present clusters that reflect the characteristics of the area to the user.

### (3) Other Embodiments

The above embodiment is an example for carrying out the various aspects of the present disclosure, and a variety of other embodiments can be adopted as long as cluster information on clusters formed by clustering a plurality of facilities and including associated facilities associated with the designated position is presented to the user. Some of the components according to the embodiment discussed above may be omitted, the order of the processes may be changed, or some of the processes may be omitted. For example, each of the in-vehicle system 100 and the server system 200 may be constituted from two or more devices, rather than being constituted from a single device. The control unit 210 may execute the process in step S115 in the middle of the processes in steps S125 to S145, for example. The control unit 210 may transmit the information transmitted in step S115 and step S150 in combination to the in-vehicle system 100 after the process in step S145 is completed, for example.

In the embodiment discussed above, the in-vehicle system 100 is a car navigation system. However, the in-vehicle system 100 may be constituted of a different device such as a smartphone or a tablet device. In the embodiment discussed above, the server system 200 performs control so as to cluster a plurality of images to be clustered, and cause the input/output unit 120 to output cluster information on clusters formed as a result of the clustering and including images about associated facilities associated with the designated position. However, the in-vehicle system 100 may perform the same process as the process performed by the server system 200. In that case, the in-vehicle system 100 implements the same function (excluding the function of communicating with the in-vehicle system 100) as that implemented by the server system 200 with the storage unit of the in-vehicle system 100 storing the same data as those stored in the storage unit 230 of the server system 200 and with the control unit 110 of the in-vehicle system 100 executing the same program as the presentation control program 211.

In the embodiment discussed above, the control unit 210 clusters a plurality of objects about a plurality of facilities to be clustered. However, the control unit 210 may save clustering a plurality of objects to be clustered, by using the result of clustering the plurality of objects in advance. For example, the control unit 210 may save performing the process in step S135 in the case where information on the result of clustering a plurality of objects to be clustered is stored in advance in the storage unit 230. In that case, the control unit 210 may determine output clusters from the clusters indicated by the information on the result of the clustering stored in the storage unit 230 in step S140. The control unit 210 may acquire information on the result of clustering a plurality of objects to be clustered in advance from an external device, for example. In this case, the control unit 210 may determine output clusters from the clusters indicated by the acquired information in step S140 without performing the process in step S135.

In the embodiment discussed above, the control unit 210 clusters the target objects using a k-means algorithm. However, the control unit 210 may cluster the target objects using a method that is different from the k-means algorithm. For example, the control unit 210 may cluster the target objects using a hierarchical cluster analysis method such as a Ward's method and a farthest neighbor method. In this case, it is not necessary that the control unit 210 should determine the number of clusters before clustering. Alternatively, the control unit 210 may cluster the target objects using a non-hierarchical cluster analysis method that is different from the k-means algorithm.

In the embodiment discussed above, the cluster information is images included in the corresponding cluster. However, the cluster information may be different information. For example, the cluster information may be information that indicates the attribute of the corresponding cluster (e.g. the genre of food and drink indicated by the images included in the cluster). The control unit 210 may recognize a subject captured in the images included in the cluster and acquire text information that indicates the recognition result as cluster information, for example. In the case where the subject captured in the images included in the cluster is Italian food and drink, for example, the control unit 210 may recognize the subject as Italian food and drink based on the images and acquire text information “Italian” as cluster information. Alternatively, the cluster information may be audio information. In the case where the cluster information is information that is different from images about facilities, the control unit 210 may output the cluster information in a manner that is different from the embodiment discussed above. In the case where the cluster information is text information, for example, the control unit 110 may cause the input/output unit 120 to display a text indicated by the cluster information. In the case where the cluster information is audio information, alternatively, the control unit 110 may cause the speaker of the input/output unit 120 to output audio indicated by the cluster information.

In the embodiment discussed above, the images as a plurality of objects to be clustered are images about a plurality of associated facilities associated with the designated position and matching a facility condition. However, the plurality of images to be clustered may be different images. For example, the plurality of images to be clustered may be images about a plurality of facilities acquired irrespective of whether or not such images are associated with the designated position. The plurality of images about a plurality of facilities to be clustered may be a plurality of images about a plurality of facilities acquired irrespective of a facility condition. For example, the control unit 210 may determine all the images, information on which is included in the object information 230b, as targets to be clustered in step S130. The control unit 210 may determine a plurality of facilities selected at random from facilities, information on which is included in the object information 230b, as targets to be clustered. The control unit 210 may determine a plurality of facilities acquired as facilities associated with the designated position as a plurality of facilities to be clustered. The control unit 210 may acquire facilities to be clustered without using a facility condition in step S130. The control unit 210 may receive designation of a plurality of facilities to be clustered and determine the plurality of designated facilities as targets to be clustered.

In the case where a facility condition is not used to acquire targets to be clustered, the control unit 110 may not receive an input of a facility condition in step S110.

In the case where a plurality of facilities to be clustered is acquired irrespective of whether not such facilities are associated with the designated position in step S130, the control unit 210 acts as follows in step S140. That is, the control unit 210 determines clusters that include facilities associated with the designated position, among the clusters formed as a result of the clustering in S135, as output clusters. Consequently, the control unit 210 presents, to the user, information on clusters that include facilities associated with the designated position. Also in this case, the user can easily grasp what facilities are included in the facilities associated with the designated position by confirming the presented information on the clusters.

In the embodiment discussed above, the plurality of objects to be clustered is a plurality of images about a plurality of facilities. However, the plurality of objects to be clustered may be objects that are different from images about facilities. For example, the plurality of objects to be clustered may be a plurality of facilities themselves. An example of the case where the plurality of objects to be clustered is a plurality of facilities themselves will be described. The object information 230b is information, for each of a plurality of predefined facilities, on the correspondence among position information on the facility, attribute information on the facility, information on a predefined image about the facility, and a predefined feature amount. However, the object information 230b may not include information on an image about the facility. The predefined feature amount is a feature amount extracted using the extraction model 230a from a predefined image about the corresponding facility. However, the predefined feature amount may be a different feature amount. For example, the predefined feature amount may be a feature amount that matches a predefined attribute of the corresponding facility, a feature amount that matches predefined text information correlated with the corresponding facility (such as reviews of the facility and reviews of food and drink served at the facility), a feature amount to which a plurality of types of feature amounts is coupled, etc.

Examples of the feature amount that matches an attribute include a vector in which numerical values correlated with attribute values for a plurality of attributes are arranged. For example, it is assumed that numerical values 1, 2, . . . , etc. are correlated with attribute values for the attribute “genre of food and drink”, such as “Italian”, “ramen”, . . . , etc. It is also assumed that numerical values 1, 2, . . . , etc. are correlated with attribute values for the attribute “price range”, such as “1000 yen or less”, “1000 yen to 2000 yen”, . . . , etc. In the case where a certain facility has “Italian” and “1000 yen to 2000 yen” as attribute values for the attributes “genre of food and drink” and “price range”, the corresponding feature amount is represented by a vector (1, 2). Examples of the feature amount that matches predefined text information correlated with the corresponding facility include a vector that matches the frequency of appearance of words in a text such as term frequency-inverse document frequency (TF-IDF), a feature vector extracted from predefined text information using an NN model such as Doc2Vec, Seq2Seq, and BERT that has been subjected to machine learning in advance, etc.

Subsequently, an example of a facility information presentation process for this case will be described. The processes in steps S100 to S125 are the same as those in the embodiment discussed above. In step S130, the control unit 210 acquires information on associated facilities associated with the designated position from the object information 230b. The control unit 210 acquires, as information on facilities associated with the designated position, information on facilities positioned along the route indicated by the designated position, among information on a plurality of facilities stored in the object information 230b. Then, the control unit 210 acquires, as information on target objects to be clustered, information on facilities, the attribute information on which matches the facility condition transmitted from the in-vehicle system 100, among information on the acquired facilities. Then, the control unit 210 proceeds to the process in step S135.

In step S135, the control unit 210 acquires feature amounts correlated with the target objects from the object information 230b. Then, the control unit 210 clusters the target objects using a predefined method (e.g. a k-means algorithm etc.) using the acquired feature amounts. When the target objects are clustered, the control unit 210 proceeds to the process in step S140.

In step S140, the control unit 210 determines clusters for which cluster information is to be output from the clusters formed as a result of the clustering performed in step S135 through the function of the output control unit 211c. The control unit 210 determines, as output clusters for which cluster information is to be output, a predefined number of clusters determined sequentially in the descending order of the number of images included therein, among the obtained clusters. When clusters for which cluster information is to be output are determined, the control unit 210 proceeds to the process in step S145.

In step S145, the control unit 210 acquires cluster information for each of the output clusters. Specifically, the control unit 210 extracts, for each of the output clusters, a predefined number of images, the feature amounts corresponding to which are the closest to the center of gravity of the cluster, among the facilities included in the cluster, as facilities that represent the cluster. In a different example, however, the control unit 210 may extract facilities that represent the cluster from the facilities included in the cluster by a different method. For example, the control unit 210 may arrange the facilities included in the cluster in the order of closeness of the corresponding feature amount to the center of gravity of the cluster and select representative facilities using a predefined number of quantiles. The control unit 210 may extract a predefined number of facilities at random from the facilities included in the cluster as facilities that represent the cluster. Then, the control unit 210 acquires, for each of the output clusters, an image corresponding to each of the facilities that represent the cluster extracted from the object information 230b. The control unit 210 determines, for each of the output clusters, the acquired image as cluster information on the output cluster. When cluster information is acquired for each of the output clusters, the control unit 210 proceeds to the process in step S150.

The processes in steps S150 to S165 are the same as those in the embodiment discussed above. When the information transmitted in step S165 is received, the control unit 210 of the server system 200 acquires information on facilities included in the cluster indicated by the received information from the object information 230b in step S170. The control unit 210 acquires, for the facilities included in the cluster, information such as the positions of the facilities and the names of the facilities and images about the facilities from the object information 230b. Then, the control unit 210 transmits the acquired information to the in-vehicle system 100.

The processes in steps S175 to S195 are the same as those in the embodiment discussed above. The facility information presentation system 1 may perform a facility information presentation process using a plurality of facilities themselves as targets to be clustered as described above. In this case, the object information 230b may not include information on images about the facilities. In the case where the object information 230b does not include information on images about the facilities, the control unit 210 uses information that is different from images about the facilities (e.g. the attribute values of the facilities (such as name and genre of food and drink) etc.) as the cluster information.

In the embodiment discussed above, the control unit 210 clusters images, which are a plurality of objects about a plurality of facilities, based on feature amounts extracted from the images about the facilities using the extraction model 230a. However, the control unit 210 may cluster a plurality of images based on different feature amounts for the images. For example, the control unit 210 may cluster a plurality of images based on a predefined type of feature amounts (e.g. histograms of oriented gradients (HOG), scale-invariant feature transform (SHIFT), etc.) of images about facilities. The control unit 210 may cluster a plurality of images based on feature amounts obtained by coupling a plurality of types of feature amounts.

In the embodiment discussed above, the control unit 210 determines, as clusters for which cluster information is to be output, a predefined number of clusters determined sequentially in the descending order of the number of objects included therein from the clusters formed as a result of clustering the target objects. However, the control unit 210 may determine clusters for which cluster information is to be output by a different method based on the number of objects included in each of the formed clusters. For example, the control unit 210 may select a predefined number of clusters from clusters formed and including a threshold number of objects or more and determine the selected clusters as clusters for which cluster information is to be output. The control unit 210 may determine, as clusters for which cluster information is to be output, a predefined number of clusters determined sequentially in the ascending order of the number of objects included in each of the formed clusters. The control unit 210 may determine clusters for which cluster information is to be output by a different method without using the number of objects included in the clusters. For example, the control unit 210 may determine all of the formed clusters as clusters for which cluster information is to be output. The control unit 210 may select a predefined number of clusters at random from the formed clusters and determine the selected clusters as clusters for which cluster information is to be output. The control unit 210 may determine clusters for which cluster information is to be output as follows. It is assumed that an image (e.g. an image of food and drink) is designated by the user via the input/output unit 120 in the in-vehicle system 100. The control unit 210 acquires the image from the in-vehicle system 100, and extracts a feature amount from the acquired image using the extraction model 230a. Then, the control unit 210 may determine, as clusters for which cluster information is to be output, clusters of which the center of gravity in the feature amount space is the closest to the extracted feature amount, among the clusters formed as a result of the clustering performed through the function of the clustering unit 211b.

In the case where there exists profile information about the interest of the user, the control unit 210 may determine clusters for which cluster information is to be output based on the profile information. Examples of the profile information include information on an attribute value that the user has interest in for a predefined attribute (e.g. information on the attribute value “Italian” in the case where the user have interest in Italian for the attribute “genre of food and drink”). For example, the control unit 210 may determine clusters that include objects about facilities that have an attribute value indicated by the profile information as clusters for which cluster information is to be output. In the case where the clusters include objects about facilities that have an attribute value indicated by the profile information and objects about facilities that do not, the control unit 210 may act as follows. That is, if the proportion of the objects about facilities that have an attribute value indicated by the profile information in the clusters is a predefined threshold or more, the control unit 210 may determine such clusters as clusters for which cluster information is to be output. Consequently, the in-vehicle system 100 can present, to the user, clusters about facilities in which the user is highly interested. The control unit 210 may determine, as clusters for which cluster information is to be output, clusters that do not include objects about facilities that have an attribute value indicated by the profile information, for example. Consequently, the in-vehicle system 100 can present, to the user, clusters about facilities that are unpredictable for the user.

In the embodiment discussed above, the control unit 210 acquires the position of a route from the departure location to the destination as the designated position. However, the control unit 210 may acquire a different position as the designated position. For example, the control unit 210 may acquire, as the designated position, the present location of the vehicle, a location at a latitude and a longitude designated by the user, a location designated on a map by the user, a location at which a facility designated by the user exists, etc.

The output control unit may perform control so as to cause the output unit to directly output cluster information, or may perform control so as to cause the output unit to output cluster information indirectly via a different device.

Further, the aspects of the present disclosure is also applicable as a program and a method. The system described above, the program, and the method are occasionally implemented as an independent device, and occasionally implemented by sharing a component with various parts of the vehicle, and include various aspects. The present invention may be changeable as appropriate, such as being partly implemented by software and partly implemented by hardware. Further, the aspects of the present disclosure may be implemented as a storage medium for the program that controls the system. As a matter of course, the storage medium for the program may be a magnetic storage medium, a semiconductor memory, or any storage medium to be developed in the future.

What is claimed is:

1. An information processing system comprising:
a position acquisition unit that acquires a designated position; and an output control unit that causes an output unit to output cluster information based on a result of clustering target objects by using a feature amount corresponding to each of the target objects, in which the target objects are a plurality of objects about a plurality of facilities, the cluster information being information on clusters to which objects about associated facilities belong and including images about the associated facilities, in which the facilities are associated with the position.

2. The information processing system according to claim 1, wherein the output control unit causes the output unit to selectably output the cluster information for each of the clusters.

3. The information processing system according to claim 2, wherein the output control unit causes the output unit to output information on the associated facilities that belong to the cluster information selected from the selectably output cluster information and including facility names of the associated facilities.

4. The information processing system according to claim 2, wherein when the cluster information is selected, the output control unit causes the output unit to display information on facilities corresponding to the objects included in the cluster corresponding to the selected cluster information in combination with a map.

5. The information processing system according to claim 1, wherein the output control unit causes the output unit to output the cluster information corresponding to the cluster selected based on profile information about interest of a user.

6. The information processing system according to claim 1, wherein:
the plurality of facilities is the associated facilities;
the information processing system further includes a clustering unit that clusters the target objects in accordance with the feature amount corresponding to each of the target objects about the associated facilities; and
the cluster information to be output is information on clusters formed by the clustering unit clustering the target objects.

7. The information processing system according to claim 3, wherein when the cluster information is selected, the output control unit causes the output unit to display information on facilities corresponding to the objects included in the cluster corresponding to the selected cluster information in combination with a map.

8. The information processing system according to claim 2, wherein the output control unit causes the output unit to output the cluster information corresponding to the cluster selected based on profile information about interest of a user.

9. The information processing system according to claim 3, wherein the output control unit causes the output unit to output the cluster information corresponding to the cluster selected based on profile information about interest of a user.

10. The information processing system according to claim 4, wherein the output control unit causes the output unit to output the cluster information corresponding to the cluster selected based on profile information about interest of a user.

11. The information processing system according to claim 2, wherein:
the plurality of facilities is the associated facilities;
the information processing system further includes a clustering unit that clusters the target objects in accordance with the feature amount corresponding to each of the target objects about the associated facilities; and
the cluster information to be output is information on clusters formed by the clustering unit clustering the target objects.

12. The information processing system according to claim 3, wherein:
the plurality of facilities is the associated facilities;
the information processing system further includes a clustering unit that clusters the target objects in accordance with the feature amount corresponding to each of the target objects about the associated facilities; and
the cluster information to be output is information on clusters formed by the clustering unit clustering the target objects.

13. The information processing system according to claim 4, wherein:
the plurality of facilities is the associated facilities;
the information processing system further includes a clustering unit that clusters the target objects in accordance with the feature amount corresponding to each of the target objects about the associated facilities; and
the cluster information to be output is information on clusters formed by the clustering unit clustering the target objects.

14. The information processing system according to claim 5, wherein:
the plurality of facilities is the associated facilities;
the information processing system further includes a clustering unit that clusters the target objects in accordance with the feature amount corresponding to each of the target objects about the associated facilities; and
the cluster information to be output is information on clusters formed by the clustering unit clustering the target objects.
